(19) United States
(12) Patent Application Publication
(10) Pub. No.: US 2022/0211234 A1
(43) Pub. Date: Jul. 7, 2022

(54) VACUUM CLEANER

(71) Applicant: SUZHOU ALTON ELECTRICAL & MECHANICAL INDUSTRY CO., LTD., Suzhou (CN)

(72) Inventors: Weidong LU, Suzhou (CN); Shuhua SANG, Suzhou (CN); Xiaoyu LIU, Suzhou (CN)

(21) Appl. No.: 17/604,978

(22) PCT Filed: May 19, 2020
(86) PCT No.: PCT/CN2020/090990

§ 371 Date: Oct. 19, 2021

(30) Foreign Application Priority Data
Mar. 18, 2020 (CN) 202020346376.9

(51) Int. Cl. A47L 9/20; A47L 5/36; A47L 9/12; B01D 46/58; B01D 46/24; B01D 46/71; B01D 46/42; B01D 46/00; F16K 11/076; F16K 51/02

(52) U.S. Cl. CPC A47L 9/20; A47L 5/365; A47L 9/127; B01D 46/58; B01D 46/2403; B01D 46/71; B01D 2279/55; B01D 46/0043; F16K 11/076; F16K 51/02; B01D 2273/30; B01D 2271/02; B01D 46/4272

(57) ABSTRACT

Provided is a vacuum cleaner. The switching valve apparatus of the vacuum cleaner includes an outer casing and a counterflow air passage. The outer casing is provided with a first vent opening and a second vent opening arranged side by side along the circumferential direction of the outer casing. In the case where the counterflow air passage is at the first angular position, the outer casing seals the counterflow air outlet of the counterflow air passage; in the case where the counterflow air passage is at the second angular position, the counterflow air outlet communicates with the first vent opening and is staggered with the second vent opening; and in the case where the counterflow air passage is at the third angular position, the counterflow air outlet communicates with the second vent opening and is staggered with the first vent opening.

This application claims priority to Chinese Patent Application No. 202020346376.9 filed Mar. 18, 2020, the disclosure of which is incorporated herein by reference in its entirety.

### TECHNICAL FIELD

The present application relates to a vacuum cleaner, for example, an air passage switching device of the vacuum cleaner.

### BACKGROUND

A filter of a vacuum cleaner gradually becomes blocked after being used for some time, resulting in a decrease in the filtration performance. Patent application US20160331198 published on Nov. 17, 2016 discloses a vacuum cleaner. This vacuum cleaner has two sets of butterfly valves and two sets of solenoid driving devices for driving the corresponding butterfly valves to move. The two sets of butterfly valves switch the air passage so that the airflow discharged by the fan may flow through one of the filters in the reverse direction, the dust and other blockages attached to this filter are blown away, and thus the blockages in this filter can be effectively reduced. The present application provides an air passage switching apparatus with another configuration, which may also be effectively applied to the blockage cleaning of the filter of the vacuum cleaner.

### SUMMARY

The present disclosure provides a vacuum cleaner provided with a switching valve apparatus that switches an air passage more conveniently.

A vacuum cleaner includes a dust collection container, a fan, a first filter, a second filter, and a switching valve apparatus. The switching valve apparatus includes an outer casing and a counterflow air passage at least partially located in the outer casing. The outer casing is provided a first vent opening corresponding to the first filter and a second vent opening corresponding to the second filter. The first vent opening and the second vent opening are disposed on the outer periphery of the outer casing and arranged side by side along the circumferential direction of the outer casing. The counterflow air passage is rotatable to different angular positions relative to the outer casing so that the counterflow air passage may selectively communicate with the first vent opening or communicate with the second vent opening or not be aligned with and thus not in communication with the first vent opening and the second vent opening. The counterflow air passage is provided with a counterflow air outlet. In the case where the counterflow air passage is at a first angular position, the counterflow air outlet is staggered with the first vent opening and the second vent opening, and the outer casing seals the counterflow air outlet. In this case, under the suction of the fan, the airflow filtered by the first filter flows through at least the first vent opening to the suction port of the fan, and the airflow filtered by the second filter flows through at least the second vent opening to the suction port of the fan. In the case where the counterflow air passage is at a second angular position, the counterflow air outlet communicates with the first vent opening and is staggered with the second vent opening. In this case, under the suction of the fan, the airflow filtered by the second filter flows through at least the second vent opening to the suction port of the fan, and the air flows backward into the dust collection container through at least the counterflow air passage, the counterflow air outlet, the first vent opening, and the first filter in sequence. In the case where the counterflow air passage is at a third angular position, the counterflow air outlet communicates with the second vent opening and is staggered with the first vent opening. In this case, under the suction of the fan, the airflow filtered by the first filter flows through at least the first vent opening to the suction port of the fan, and the air flows backward into the dust collection container through at least the counterflow air passage, the counterflow air outlet, the second vent opening, and the second filter in sequence.

In the switching valve apparatus of this vacuum cleaner, the counterflow air passage rotates to different angular positions relative to the outer casing so that the air passage can be switched more conveniently and efficiently.

Optionally, the vacuum cleaner further includes a first chamber, a second chamber, and a third chamber. The outer casing is further provided with a first air outlet located on the outer periphery of the outer casing. The first vent opening faces the first chamber along a radial direction of the outer casing. The second vent opening faces the second chamber along a radial direction of the outer casing. The first air outlet faces the third chamber along a radial direction of the outer casing. In the case where the counterflow air passage is at the first angular position, the first vent opening is communicated between the first chamber and the first air outlet, and the second vent opening is communicated between the second chamber and the first air outlet. In the case where the counterflow air passage is at the second angular position, the first vent opening is communicated between the first chamber and the counterflow air passage, and the second vent opening is communicated between the second chamber and the first air outlet. In the case where the counterflow air passage is at the third angular position, the first vent opening is communicated between the first chamber and the first air outlet, and the second vent opening is communicated between the second chamber and the counterflow air passage.

Optionally, the outer casing is further provided with a first cylindrical wall. The first cylindrical wall surrounds the outer periphery of the counterflow air passage, and the first vent opening and the second vent opening are separately disposed on the first cylindrical wall.

Optionally, the outer casing is further provided with a first counterflow inlet and a second counterflow inlet. The first counterflow inlet and the second counterflow inlet are separately disposed on the first cylindrical wall. The counterflow air passage is provided with a counterflow air inlet. In the case where the counterflow air passage is at the second angular position, the counterflow air inlet is aligned with and thus communicates with the first counterflow inlet, and the counterflow air outlet is aligned with and thus communicates with the first vent opening. In the case where the counterflow air passage is at the third angular position, the counterflow air inlet is aligned with and thus communicates with the second counterflow inlet, and the counterflow air outlet is aligned with and thus communicates with the second vent opening.

Optionally, the vacuum cleaner further includes a tray and a lower cover located on the lower side of the tray. The tray is provided with a first installation through opening penetrating through the upper side of the tray and the lower side of the tray. The first cylindrical wall penetrates through the first installation through opening in the up-and-down direction. The first vent opening and the second vent opening are separately located between the tray and the lower cover. The first counterflow flow air inlet and the second counterflow inlet are separately located on the upper side of the tray.

Optionally, the switching valve apparatus further includes a valve core at least partially accommodated in the outer casing and rotatable relative to the outer casing. The counterflow air passage is disposed in the valve core. The valve core is further provided with a second cylindrical wall. The first cylindrical wall is sleeved outside the second cylindrical wall. The counterflow air outlet is disposed on the second cylindrical wall. In the case where the counterflow air passage is at the first angular position, the first cylindrical wall seals the counterflow air outlet.

Optionally, the counterflow air passage is further provided with a counterflow air inlet. The counterflow air inlet is disposed on the second cylindrical wall. In the case where the counterflow air passage is at the first angular position, the first cylindrical wall seals the counterflow air inlet.

Optionally, the outer casing is further provided with a first counterflow inlet and a second counterflow inlet. The first counterflow inlet and the second counterflow inlet are separately disposed on the first cylindrical wall. In the case where the counterflow air passage is at the second angular position, the counterflow air inlet communicates with the first counterflow inlet, and the second cylindrical wall seals the second counterflow inlet. In the case where the counterflow air passage is at the third angular position, the counterflow air inlet communicates with the second counterflow inlet and the second cylindrical wall seals the first counterflow inlet.

Optionally, the second cylindrical wall includes a flexible sealing layer disposed on the outer peripheral surface of the second cylindrical wall. The sealing layer is used for sealing the gap between the inner surface of the first cylindrical wall and the second cylindrical wall. The first cylindrical wall and the second cylindrical wall are disposed coaxially.

Optionally, the vacuum cleaner further includes a lower cover. The first vent opening and the second vent opening are separately located on the upper side of the lower cover. The outer casing is fixed relative to the lower cover. The valve core is movable relative to the lower cover. The lower cover blocks upward the lower end of the first cylindrical wall and the lower end of the second cylindrical wall.

Optionally, the outer casing is further provided with a first counterflow inlet and a second counterflow inlet. In the case where the counterflow air passage is at the second angular position, the first counterflow inlet communicates with the first vent opening through the counterflow air passage. In the case where the counterflow air passage is at the third angular position, the second counterflow inlet communicates with the second vent opening through the counterflow air passage.

Optionally, the counterflow air passage is provided with a counterflow air inlet. The counterflow air inlet forms the air inlet of the counterflow air passage, and the counterflow air outlet forms the air outlet of the counterflow air passage. In the case where the counterflow air passage is at the second angular position, the first counterflow inlet communicates with the counterflow air inlet and the counterflow air outlet communicates with the first vent opening, so that the first counterflow inlet communicates with the first vent opening through the counterflow air passage. In the case where the counterflow air passage is at the third angular position, the second counterflow inlet communicates with the counterflow air inlet and the counterflow air outlet communicates with the second vent opening, so that the second counterflow inlet communicates with the second vent opening through the counterflow air passage.

Optionally, in the case where the counterflow air passage is at the second angular position, the first counterflow inlet is aligned with and thus communicates with the counterflow air inlet and the counterflow air outlet is aligned with and thus communicates with the first vent opening. In the case where the counterflow air passage is at the third angular position, the second counterflow inlet is aligned with and thus communicates with the counterflow air inlet and the counterflow air outlet is aligned with and thus communicates with the second vent opening.

Optionally, in the case where the counterflow air passage is at the first angular position, the outer casing seals the counterflow air outlet and the counterflow air inlet. In this case, the counterflow air outlet is staggered with the first vent opening and the second vent opening, and the counterflow air inlet is staggered with the first counterflow inlet and the second counterflow inlet.

Optionally, in the case where the counterflow air passage is at the first angular position, the first vent opening, the counterflow air outlet, and the second vent opening are arranged in sequence along the circumferential direction of the outer casing, and the first counterflow inlet, the counterflow air inlet, and the second counterflow inlet are arranged in sequence along the circumferential direction of the outer casing.

Optionally, the switching valve apparatus further includes a valve core at least partially accommodated in the outer casing and rotatable relative to the outer casing. The counterflow air passage is disposed in the valve core. The counterflow air passage rotates along with the rotation of the valve core. In the case where the counterflow air passage is at the first angular position, the valve core seals the first counterflow inlet and the second counterflow inlet.

Optionally, the first vent opening and the second vent opening are arranged side by side along the circumferential direction of the outer casing; the first counterflow inlet and the second counterflow inlet are arranged side by side along the circumferential direction of the outer casing; the first vent opening and the first counterflow inlet are arranged side by side in the height direction of the outer casing; and the second vent opening and the second counterflow inlet are arranged side by side in the height direction of the outer casing.

Optionally, the vacuum cleaner further includes a tray, a lower cover located on the lower side of the tray, and an upper cover located on the upper side of the tray. The counterflow air passage is provided with a counterflow air inlet. The first vent opening and the second vent opening are separately located between the tray and the lower cover. The first counterflow inlet and the second counterflow inlet are separately located between the tray and the upper cover. In the case where the counterflow air passage is at the second angular position, at least part of the air discharged by the fan into the space between the tray and the upper cover may flow backward into the dust collection container through at least the first counterflow inlet, the counterflow air inlet, the counterflow air passage, the counterflow air outlet, the first vent opening, and the first filter in sequence. In the case where the counterflow air passage is at the third angular position, at least part of the air discharged by the fan into the space between the tray and the upper cover may flow backward into the dust collection container through at least the second counterflow inlet, the counterflow air inlet, the counterflow air passage, the counterflow air outlet, the second vent opening, and the second filter in sequence.

Optionally, the switching valve apparatus further includes a valve core at least partially accommodated in the outer casing and rotatable relative to the outer casing. The valve core is provided with a first blocking wall and a second blocking wall. The first blocking wall and the second blocking wall are located in the outer casing. The counterflow air passage is formed between the first blocking wall and the second blocking wall. The vacuum cleaner further includes a driving motor for driving the valve core to rotate. The valve core is further provided with a center column. The driving motor may drive the center column to rotate to drive the valve core to rotate. The first blocking wall and the second blocking wall are integrated with and separately extend from the center column.

Optionally, the outer casing is further provided with a first air outlet. The first vent opening, the second vent opening, and the first air outlet are separately disposed on the outer periphery of the outer casing. In the case where the counterflow air passage is at the first angular position, the first vent opening and the second vent opening separately communicate with the first air outlet. In this case, under the suction of the fan, the airflow filtered by the first filter sequentially flows through at least the first vent opening and the first air outlet to the suction port of the fan, and the airflow filtered by the second filter sequentially flows through at least the second vent opening and the first air outlet to the suction port of the fan. In the case where the counterflow air passage is at the second angular position, the second vent opening communicates with the first air outlet. In this case, under the suction of the fan, the airflow filtered by the second filter sequentially flows through at least the second vent opening and the first air outlet to the suction port of the fan. In the case where the counterflow air passage is at the third angular position, the first vent opening communicates with the first air outlet. In this case, under the suction of the fan, the airflow filtered by the first filter sequentially flows through at least the first vent opening and the first air outlet to the suction port of the fan. The first vent opening, the second vent opening, and the first air outlet are arranged side by side along the circumferential direction of the outer casing.

### BRIEF DESCRIPTION OF DRAWINGS

FIG. 1 is a perspective view of a vacuum cleaner according to the present application;

FIG. 2 is an exploded view of the head of the vacuum cleaner (with the filters removed) according to the present application;

FIG. 3 is another exploded view of the head of the vacuum cleaner (with the filters removed) according to the present application;

FIG. 4 is a schematic view illustrating a separated state of the tray and the lower cover of the vacuum cleaner according to the present application;

FIG. 5 is a partially enlarged cross-sectional view of the head of the vacuum cleaner according to the present application (the cross-section is a horizontal plane and the valve core is at the first angular position relative to the outer casing);

FIG. 6 is a schematic view illustrating a separated state of the upper cover, the tray, and the lower cover of the vacuum cleaner according to the present application;

FIG. 7 is an exploded view of the switching valve apparatus of the vacuum cleaner according to the present application;

FIG. 8 is a schematic view illustrating a separated state of the outer casing and the valve core of the vacuum cleaner according to the present application;

FIG. 9 is a perspective view of the vacuum cleaner in the case where the switching valve apparatus and the driving motor are assembled according to the present application;

FIG. 10 is a top view of the head of the vacuum cleaner (with the housing and the upper cover removed) according to the present application;

FIG. 11 is a perspective view of the switching valve apparatus of this vacuum cleaner in the case where the valve core is at the second angular position relative to the outer casing;

FIG. 12 is a vertical sectional view of the head of the vacuum cleaner according to the present application (the valve core is at the first angular position relative to the outer casing);

FIG. 13 is a perspective view of the switching valve apparatus of this vacuum cleaner in the case where the valve core is at the third angular position relative to the outer casing;

FIG. 14 is another vertical sectional view of the head of the vacuum cleaner according to the present application;

FIG. 15 is a perspective view of the switching valve apparatus of this vacuum cleaner in the case where the valve core is at the first angular position relative to the outer casing;

FIG. 16 is a bottom view of the head of the vacuum cleaner (with the filter and the lower cover removed) according to the present application;

FIG. 17 is a partially enlarged cross-sectional view of the head of the vacuum cleaner viewed from the top according to the present application (the cross-section is a horizontal plane and the valve core is at the first angular position relative to the outer casing); and

FIG. 18 is an enlarged view of part of the structure in FIG. 12 (the valve core is at the first angular position relative to the outer casing).

### DETAILED DESCRIPTION

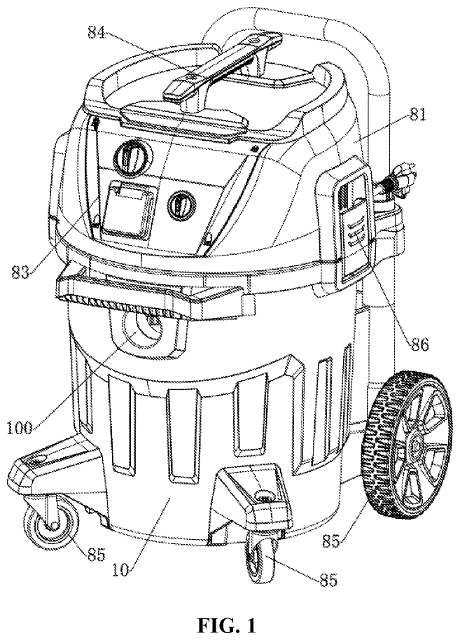

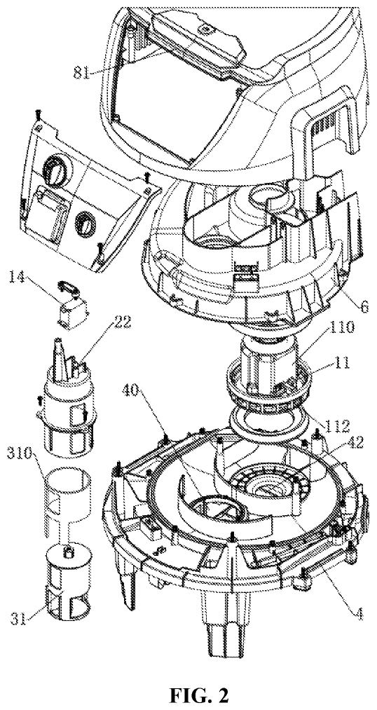

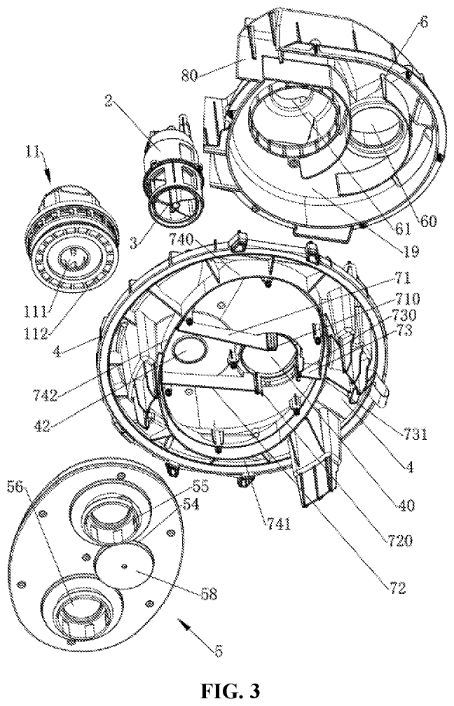

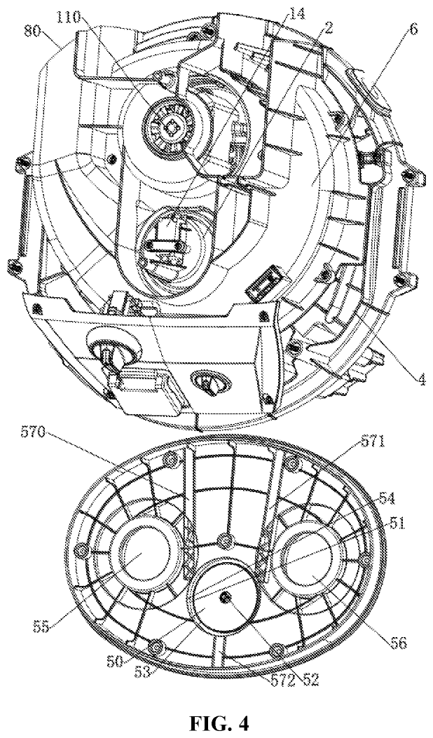

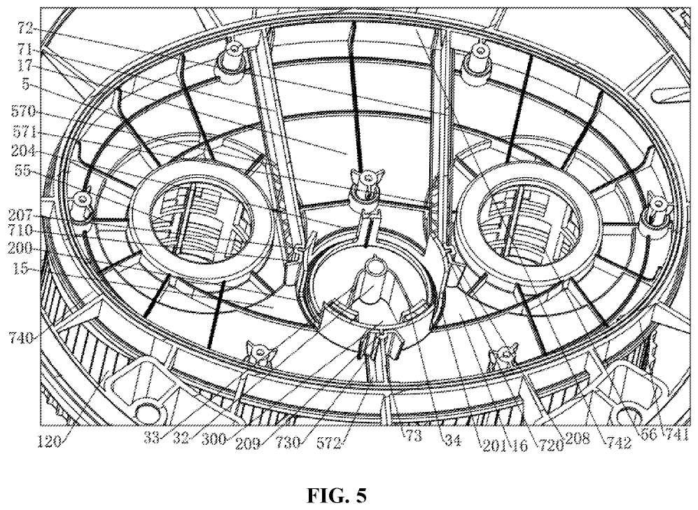

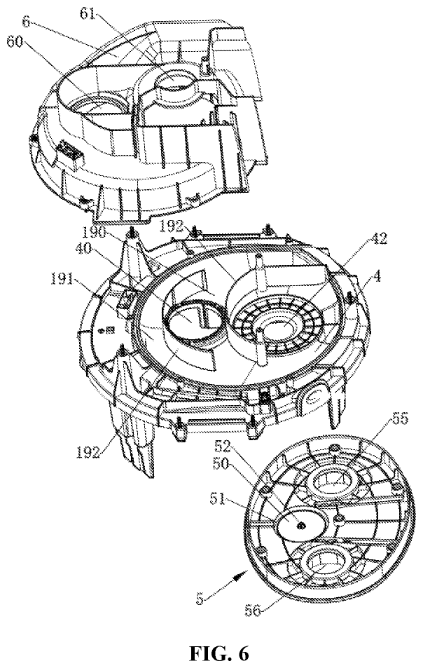

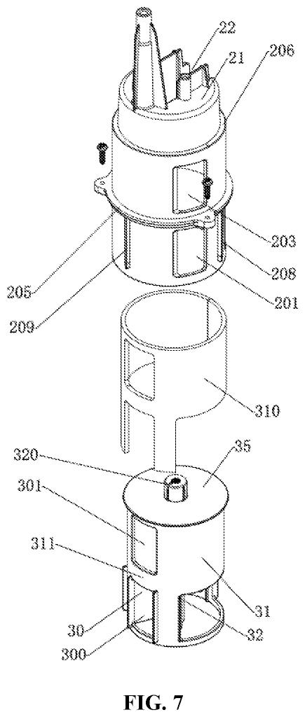

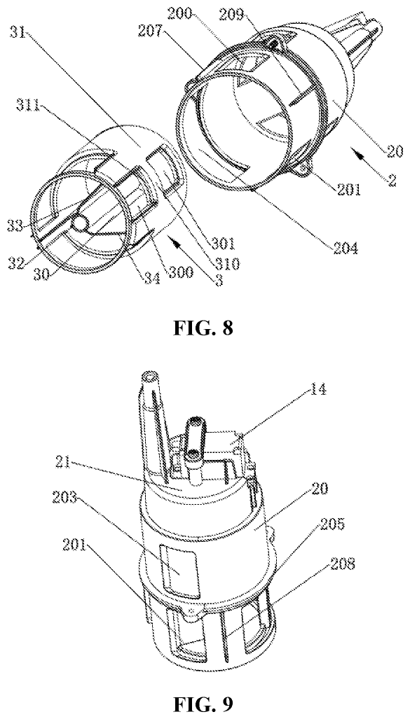

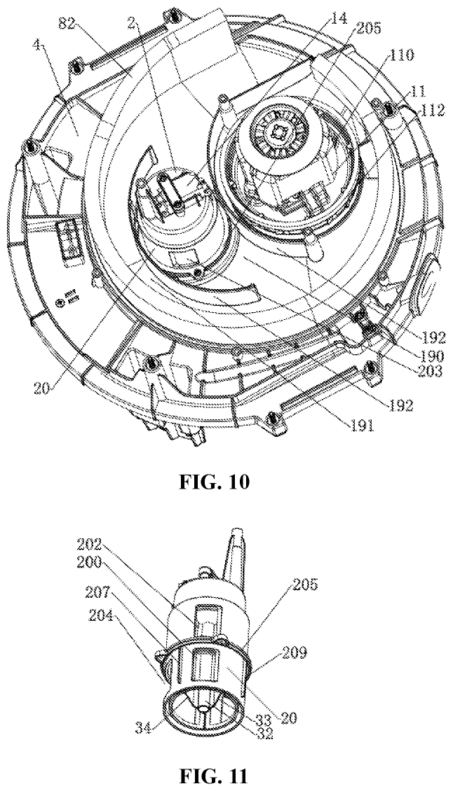

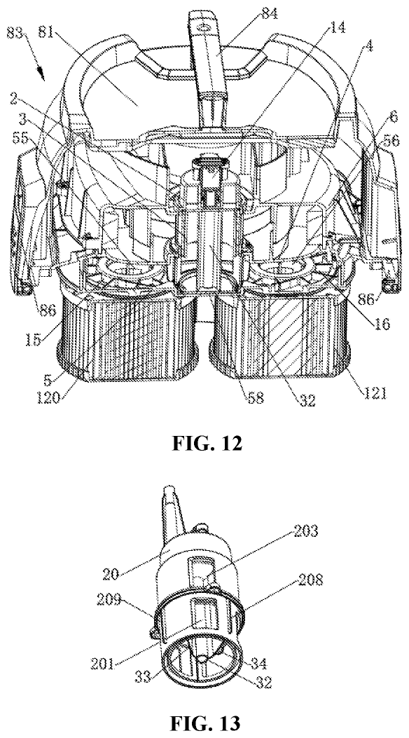

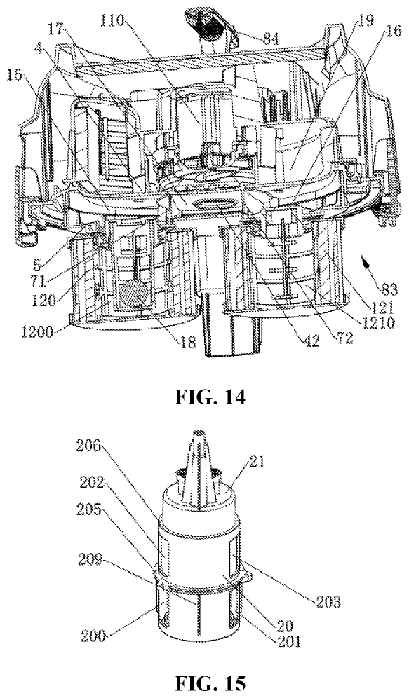

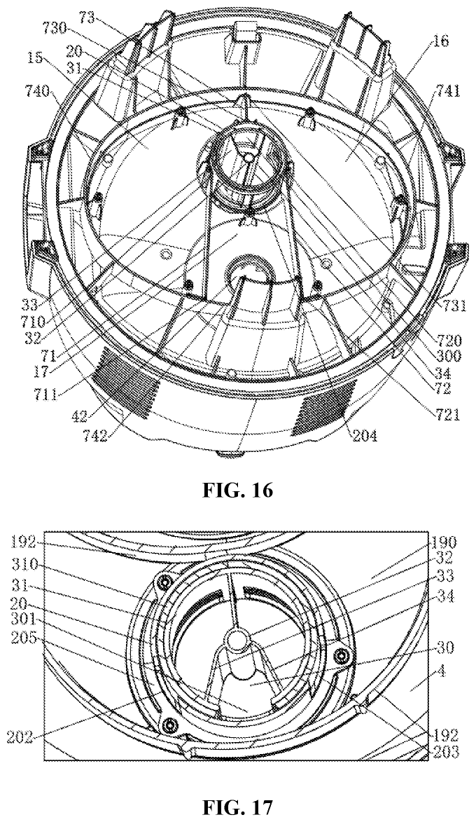

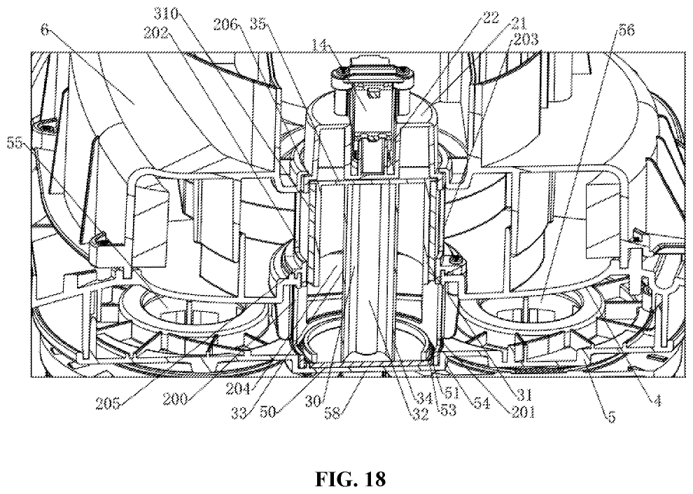

Referring to FIGS. 1 to 17, the vacuum cleaner provided in the present application includes a dust collection container 10, a fan 11, a first filter 120, a second filter 121, and a switching valve apparatus.

The dust collection container 10 is used for accommodating the dust, debris, and other garbage sucked by this vacuum cleaner. The dust collection container 10 is provided with a dirt suction port 100. The dirt suction port 100 is used for docking with a hose assembly (not shown). The hose assembly may be connected to a suction head (not shown). The garbage enters the dust collection container 10 along with the suction airflow through the suction head, the hose assembly, and the dirt suction port 100. The capacity of the dust collection container 10 is between 0.5 gallons (1 gallon=3.785412 liters) and 30 gallons and may be between 1 gallon and 20 gallons such as 6 gallons, 9 gallons, 10 gallons, 12 gallons, 14 gallons, and 16 gallons. The fan 11 operates to form the suction airflow.

The switching valve apparatus includes an outer casing 2 and a counterflow air passage 30. The outer casing 2 is provided with a first vent opening 200 corresponding to the first filter 120 and a second vent opening 201 corresponding to the second filter 121. The counterflow air passage 30 is at least partially located in the outer casing 2 and is rotatable to different angular positions relative to the outer casing 2. The counterflow air passage 30 is rotatable to different angles relative to the outer casing 2 so that the counterflow air passage 30 may be at different angular positions (for example, a first angular position, a second angular position, or a third angular position) relative to the outer casing 2. The first angular position, the second angular position, and the third angular position are different angular positions of the counterflow air passage 30 or a valve core 3 (detailed later) relative to the outer casing 2. In the case where the counterflow air passage 30 is at the first angular position relative to the outer casing 2, the first vent opening 200 is fluidly communicated between the first filter 120 and the suction port 111 of the fan 11, and the second vent opening 201 is fluidly communicated between the second filter 121 and the suction port 111 of the fan 11. In this case, under the suction of the fan 11, the airflow filtered by the first filter 120 flows through at least the first vent opening 200 to the suction port 111 of the fan 11, and the airflow filtered by the second filter 121 flows through at least the second vent opening 201 to the suction port 111 of the fan 11 so that the airflow filtered by the first filter 120 flows through at least the first vent opening 200 during flowing to the suction port 111 of the fan 11, and the airflow filtered by the second filter 121 flows through at least the second vent opening 201 during flowing to the suction port 111 of the fan 11. In the case where the counterflow air passage 30 is at the second angular position relative to the outer casing 2, the first vent opening 200 is fluidly communicated between the counterflow air passage 30 and the first filter 120, and the second vent opening 201 is fluidly communicated between the second filter 121 and the suction port 111 of the fan 11. In this case, under the suction of the fan 11, the airflow filtered by the second filter 121 flows through at least the second vent opening 201 to the suction port 111 of the fan 11, and the air flows backward into the dust collection container 10 through at least the counterflow air passage 30, the first vent opening 200, and the first filter 120 in sequence, which also means that the air flows through at least the counterflow air passage 30, the first vent opening 200, and the first filter 120 during flowing backflow into the dust collection container 10. In the case where the counterflow air passage 30 is at the third angular position relative to the outer casing 2, the second vent opening 201 is fluidly communicated between the counterflow air passage 30 and the second filter 121, and the first vent opening 200 is fluidly communicated between the first filter 120 and the suction port 111 of the fan 11. In this case, under the suction of the fan 11, the airflow filtered by the first filter 120 flows through at least the first vent opening 200 to the suction port 111 of the fan 11, and the air flows backward into the dust collection container 10 through at least the counterflow air passage 30, the second vent opening 201, and the second filter 121 in sequence, which also means that the air flows through at least the counterflow air passage 30, the second vent opening 201, and the second filter 121 during flowing backward into the dust collection container 10.

The first filter 120 and the second filter 121 are separately detachable. The fan 11 includes an impeller (not shown), a motor 110, and an impeller housing 112 for shielding the impeller. The impeller is located at the bottom of the motor 110. The shaft (not shown) of the motor 110 drives the impeller to rotate to generate the suction airflow, and thus drives the dust, debris, and other garbage are sucked into the dust collection container 10. The rated power of the fan 11 is between 100 W and 3000 W and may be between 200 W and 1800 W such as 960 W, 1200 W, 1320 W, and 1440 W.

In this embodiment, the first angular position is a position between the second angular position and the third angular position, and the counterflow air passage 30 is rotatable between the second angular position and the third angular position relative to the outer casing 2. The counterflow air passage 30 is rotatable from the first angular position to the second angular position relative to the outer casing 2 along a rotation direction, and is rotatable from the second angular position to the third angular position relative to the outer casing 2 against the rotation direction. The counterflow air passage 30 rotates from the second angular position to the third angular position through the first angular position against the rotation direction. The angular difference between the first angular position and the second angular position is a first angle, and the angular difference between the first angular position and the third angular position is a second angle. The counterflow air passage 30 rotates from the first angular position to the second angular position along the rotation direction by the first angle, and the counterflow air passage 30 rotates from the first angular position to the third angular position against the rotation direction by the second angle. The first angle is between 60 degrees and 80 degrees, and the second angle is between 60 degrees and 80 degrees. The first angle is equal to the second angle. In this embodiment, the first angle and the second angle may be 70 degrees, and the counterflow air passage 30 may rotate from the first angular position to the second angular position along the rotation direction by 70 degrees, and may rotate from the second angular position to the third angular position against the rotation direction by 140 degrees.

In the case where the counterflow air passage 30 is at the first angular position relative to the outer casing 2, the outer casing 2 seals the counterflow air passage 30. The outer casing 2 is further provided with a first counterflow inlet 202 and a second counterflow inlet 203. In the case where the counterflow air passage 30 is at the second angular position relative to the outer casing 2, the first vent opening 200 communicates with the first counterflow inlet 202 through the counterflow air passage 30 so that the air can flow into the dust collection container 10 through at least the first counterflow inlet 202, the counterflow air passage 30, the first vent opening 200, and the first filter 120 in sequence. In this case, the second vent opening 201 is staggered with the second counterflow inlet 203 and thus does not communicate with the second counterflow inlet 203. In the case where the counterflow air passage 30 is at the third angular position relative to the outer casing 2, the second vent opening 201 communicates with the second counterflow inlet 203 through the counterflow air passage 30 so that the air can flow into the dust collection container 10 through at least the second counterflow inlet 203, the counterflow air passage 30, the second vent opening 201, and the second filter 121 in sequence. In this case, the first vent opening 200 is staggered with the first air counterflow air 202 and thus does not communicate with the first counterflow inlet 202. The counterflow air passage 30 is provided with a counterflow air outlet 300 and a counterflow air inlet 301. The counterflow air inlet 301 forms the air inlet of the counterflow air passage 30, and the counterflow air outlet 300 forms the air outlet of the counterflow air passage 30. In the case where the counterflow air passage 30 is at the second angular position relative to the outer casing 2, the counterflow air inlet 301 communicates with the first counterflow inlet 202, and the counterflow air outlet 300 communicates with the first vent opening 200. In an embodiment, in the case where the counterflow air passage 30 is at the second angular position relative to the outer casing 2, the counterflow air inlet 301 is aligned with and thus communicates with the first counterflow inlet 202 and the counterflow air outlet 300 is aligned with and thus communicates with the first vent opening 200, so that the first counterflow inlet 202 communicates with the first vent opening 200 through the counterflow air passage 30. In this case, the air flows backward into the dust collection container 10 through at least the first counterflow inlet 202, the counterflow air inlet 301, the counterflow air passage 30, the counterflow air outlet 300, the first vent opening 200, and the first filter 120 in sequence so that a first counterflow airflow is formed. Since the first counterflow airflow flows through the first filter 120 in the reverse direction, the blockages in the first filter 120 can be reduced or cleared. The normal suction work of the vacuum cleaner is that the airflow that carries the dust, debris, and other garbage flows through the filter (the first filter 120 and the second filter 121) in the forward direction, the dust, debris, and other garbage are filtered out by the filter and left in the dust collection container 10. In the case where the counterflow air passage 30 is at the third angular position relative to the outer casing 2, the counterflow air inlet 301 communicates with the second counterflow inlet 203 and the counterflow air outlet 300 communicates with the second vent opening 201. In an embodiment, in the case where the counterflow air passage 30 is at the third angular position relative to the outer casing 2, the counterflow air inlet 301 is aligned with and thus communicates with the second counterflow inlet 203 and the counterflow air outlet 300 is aligned with and thus communicates with the second vent opening 201, so that the second counterflow inlet 203 communicates with the second vent opening 201 through the counterflow air passage 30. In this case, the air flows backward into the dust collection container 10 through at least the second counterflow inlet 203, the counterflow air inlet 301, the counterflow air passage 30, the counterflow air outlet 300, the second vent opening 201, and the second filter 121 in sequence so that a second counterflow airflow is formed. Since the second counterflow airflow flows through the second filter 121 in the reverse direction, the blockages in the second filter 121 can be reduced or cleared. The airflow that carries the dust, debris, and other garbage flows through the filter in the forward direction, and thus the filter may be gradually blocked, and the filtration performance may be reduced. The airflow flowing through the filter (the first filter 120 and the second filter 121) in the reverse direction is compared with the aforementioned forward direction. The airflow flows through the filter in the reverse direction, and thus the blockages in the filter can be gradually reduced.

In the case where the counterflow air passage 30 is at the first angular position relative to the outer casing 2, the outer casing 2 seals the counterflow air outlet 300 and the counterflow air inlet 301. In this case, the counterflow air outlet 300 is staggered with the first vent opening 200 and the second vent opening 201, and the counterflow air inlet 301 is staggered with the first counterflow inlet 202 and the second counterflow inlet 203. Moreover, in this case, the first vent opening 200, the counterflow air outlet 300, and the second vent opening 201 are arranged in sequence along the circumferential direction of the outer casing 2, and the first counterflow inlet 202, the counterflow air inlet 301, and the second counterflow inlet 203 are arranged in sequence along the circumferential direction of the outer casing 2. The outer casing 2 is further provided with a first air outlet 204. The first air outlet 204 is used for being fluidly communicated between the first vent opening 200 and the suction port 111 of the fan 11 and for being fluidly communicated between the second vent opening 201 and the suction port 111 of the fan 11. In the case where the counterflow air passage 30 is at the first angular position, the first air outlet 204 and the counterflow air outlet 300 are located on two opposite sides of the outer casing 2 along the radial direction of the outer casing 2.

The switching valve apparatus further includes a valve core 3. The valve core 3 is at least partially accommodated in the outer casing 2 and is rotatable relative to the outer casing 2. The counterflow air passage 30 is disposed in the valve core 3, and the counterflow air passage 30 is part of the valve core 3. Since the counterflow air passage 30 is part of the valve core 3, the counterflow air passage 30 being at the first angular position means that the valve core 3 is at the first angular position, the counterflow air passage 30 being at the second angular position means that the valve core 3 is at the second angular position, and the counterflow air passage 30 being at the third angular position means that the valve core 3 is at the third angular position. The counterflow air passage 30 rotates along with the rotation of the valve core 3. The valve core 3 rotates to different angles relative to the outer casing 2, and thus the counterflow air passage 30 is driven to rotate to different angles. Similar to the counterflow air passage 30, the valve core 3 is rotatable from the first angular position to the second angular position relative to the outer casing 2 and is rotatable back and forth between the second angular position and the third angular position relative to the outer casing 2. The valve core 3 may rotate from the first angular position to the second angular position along the rotation direction by the first angle, and the valve core 3 may rotate from the first angular position to the third angular position against the rotation direction by the second angle. In the case where the counterflow air passage 30 is at the first angular position, or in the case where the valve core 3 is at the first angular position, the valve core 3 seals the first counterflow inlet 202 and the second counterflow inlet 203.

The first vent opening 200, the second vent opening 201, the first counterflow inlet 202, and the second counterflow inlet 203 are separately located on the outer periphery of the outer casing 2. The first vent opening 200 and the second vent opening 201 are arranged side by side along the circumferential direction of the outer casing 2. The first counterflow inlet 202 and the second counterflow inlet 203 are arranged side by side along the circumferential direction of the outer casing 2. The first vent opening 200 and the first counterflow inlet 202 are arranged side by side in the height direction of the outer casing 2. The second vent opening 201 and the second counterflow inlet 203 are arranged side by side in the height direction of the outer casing 2. The outer casing 2 is further provided with a first cylindrical wall 20. The first cylindrical wall 20 surrounds the outer periphery of the counterflow air passage 30. The first vent opening 200, the second vent opening 201, the first counterflow inlet 202, the second counterflow inlet 203, and the first air outlet 204 are separately provided on the first cylindrical wall 20. The first vent opening 200 and the second vent opening 201 are arranged side by side along the circumferential direction of the first cylindrical wall 20. The first counterflow inlet 202 and the second counterflow inlet 203 are arranged side by side along the circumferential direction of the first cylindrical wall 20. The first vent opening 200 and the first counterflow inlet 202 are arranged side by side in the height direction of the first cylindrical wall 20. The second vent opening 201 and the second counterflow inlet 203 are arranged side by side in the height direction of the first cylindrical wall 20. The first vent opening 200 and the second vent opening 201 are located at the lower part of the first cylindrical wall 20, and the first counterflow inlet 202 and the second counterflow inlet 203 are located at the upper part of the first cylindrical wall 20. In the case where the valve core 3 is at the first angular position, the first air outlet 204 and the counterflow air outlet 300 are located on two opposite sides of the first cylindrical wall 20 along the radial direction of the first cylindrical wall 20.

The vacuum cleaner further includes a tray 4, a lower cover 5, and an upper cover 6. The tray 4 is provided with a first installation through opening 40 penetrating through the upper side of the tray 4 and the lower side of the tray 4, and the first cylindrical wall 20 penetrates through the first installation through opening 40. The counterflow air outlet 300, the first vent opening 200, and the second vent opening 201 are separately located between the tray 4 and the lower cover 5. The counterflow air inlet 301, the first counterflow inlet 202, and the second counterflow inlet 203 are separately located between the tray 4 and the upper cover 6. The counterflow air outlet 300, the first vent opening 200, and the second vent opening 201 are separately located on the lower side of the tray 4. The counterflow air inlet 301, the first counterflow inlet 202, and the second counterflow inlet 203 are separately located on the upper side of the tray 4. The upper cover 6 is located on the upper side of the tray 4, and the lower cover 5 is located on the lower side of the tray 4. The tray 4 is roughly disc-shaped. The switching valve apparatus is perpendicular to the tray 4.

The first cylindrical wall 20 has a shape of a hollow cylinder. The first cylindrical wall 20 is provided with a ring-shaped flange 205 surrounding the outer periphery of the first cylindrical wall 20. The first vent opening 200 and the second vent opening 201 are located on the lower side of the ring-shaped flange 205. The counterflow air inlet 202 and the second counterflow inlet 203 are located on the upper side of the ring-shaped flange 205. The ring-shaped flange 205 abuts against the periphery of the first installation through opening 40. The first installation through opening 40 is circular, and the ring-shaped flange 205 is fastened to the tray 4 through screws so that the outer casing 2 is fastened to the tray 4. The ring-shaped flange 205 may be provided with a ring-shaped rib (not shown). The ring-shaped rib surrounds the outer periphery of the first cylindrical wall 20. The tray 4 is further provided with a ring-shaped groove (not shown) surrounding the first installation through opening 40. The ring-shaped rib is embedded in the ring-shaped groove to enhance the positioning between the ring-shaped flange 205 and the tray 4. The ring-shaped flange 205 is located on the upper side of the tray 4. The ring-shaped flange 205 protrudes downward and abuts downward against the outer periphery of the first installation through opening 40. The ring-shaped rib is downwardly embedded in the ring-shaped groove.

The upper cover 6 is provided with a second installation through opening 60 penetrating through the upper side of the upper cover 6 and the lower side of the upper cover 6, and a third installation through opening 61 penetrating through the upper side of the upper cover 6 and the lower side of the upper cover 6. The first cylindrical wall 20 penetrates through the second installation through opening 60. The second installation through opening 60 faces downward to the first installation through opening 40. The first counterflow inlet 202 and the second counterflow inlet 203 are located between the first installation through opening 40 and the second installation through opening 60. The upper cover 6 is fastened to the tray 4 through screws. The upper part of the fan 11 is exposed outside the third installation through opening 61.

The first cylindrical wall 20 is further provided with a ring-shaped shoulder portion 206. The first counterflow inlet 202 and the second counterflow inlet 203 are located on the lower side of the ring-shaped shoulder portion 206. The ring-shaped shoulder portion 206 abuts upward against the periphery of the second installation through opening 60. The upper cover 6 covers part of the first cylindrical wall 20 between the first installation through opening 40 and the second installation through opening 60. From another perspective, the upper cover 6 covers part of the first cylindrical wall 20 between the ring-shaped shoulder portion 206 and the ring-shaped flange 205. The part of the first cylindrical wall 20 located on the upper side of the ring-shaped shoulder portion 206 is exposed outside the second installation through opening 60. The first counterflow inlet 202 and the second counterflow inlet 203 are located between the ring-shaped shoulder portion 206 and the ring-shaped flange 205.

The valve core 3 is further provided with a second cylindrical wall 31. The second cylindrical wall 31 surrounds the rotation axis of the valve core 3 (the rotation axis of the valve core 3 is the central axis around which the valve core 3 rotates and is a virtual straight line). The first cylindrical wall 20 and the second cylindrical wall 31 are disposed coaxially. In this embodiment, the extending direction of the rotation axis of the valve core 3, the axial direction of the first cylindrical wall 20, and the axial direction of the second cylindrical wall 31 are the up-and-down direction. The first cylindrical wall 20 is sleeved outside the second cylindrical wall 31, and the counterflow air passage 30 is at least partially located in the second cylindrical wall 31. The counterflow air outlet 300 and the counterflow air inlet 301 are separately provided on the second cylindrical wall 31. In the case where the valve core 3 is at the first angular position, the first cylindrical wall 20 seals the counterflow air outlet 300 and the counterflow air inlet 301. In the case where the valve core 3 is at the second angular position, the second cylindrical wall 31 seals the second counterflow inlet 203. Moreover, in this case, the counterflow air inlet 301 communicates with the first counterflow inlet 202, and the counterflow air outlet 300 communicates with the first vent opening 200. In the case where the valve core 3 is at the third angular position, the second cylindrical wall 31 seals the first counterflow inlet 202. Moreover, in this case, the counterflow air inlet 301 communicates with the second counterflow inlet 203, and the counterflow air outlet 300 communicates with the second vent opening 201. In this embodiment, the rotation axis of the motor 110 extends in the up-and-down direction, the rotation axis of the fan 11 is parallel to the rotation axis of the valve core 3, and the shaft of the motor 110 is parallel to the center column 32 of the valve core 3.

The second cylindrical wall 31 includes a flexible sealing layer 310 disposed on the outer peripheral surface of the second cylindrical wall 31 and a partition 31. The sealing layer 310 seals the gap between the inner surface of the first cylindrical wall 20 and the second cylindrical wall 31 to achieve the necessary seal between the first cylindrical wall 20 and the second cylindrical wall 31. In this embodiment, the sealing layer 310 is pasted on the outer peripheral surface of the second cylindrical wall 31 and thus may be considered as part of the second cylindrical wall 31, and the sealing layer 310 rotates with the second cylindrical wall 31. The sealing layer 310 may be made of PU material (that is, polyurethane material) or EVA material (that is, ethylene-vinyl acetate copolymer material). The partition 311 separates the counterflow air outlet 300 and the counterflow air inlet 301 in the up-and-down direction. Part of the sealing layer 310 is attached to the outer surface of the partition 311 to achieve the necessary seal between the partition 311 and the first cylindrical wall 20.

The valve core 3 is further provided with a center column 32, a first blocking wall 33, a second blocking wall 34, and a first end wall 35. The first blocking wall 33 and the second blocking wall 34 separately extend from the center column 32 to the second cylindrical wall 31, and the counterflow air passage 30 is formed between the first blocking wall 33 and the second blocking wall 34. The first end wall 35 is connected to the upper end of the second cylindrical wall 31. The upper end of the first blocking wall 33 and the upper end of the second blocking wall 34 are separately integrally connected to the first end wall 35. The first end wall 35 is perpendicular to the rotation axis of the valve core 3. The counterflow air inlet 301 is located between the counterflow air outlet 300 and the first end wall 35, and the first end wall 35 is roughly a circular plate.

The first vent opening 200 and the second vent opening 201 are separately located on the upper side of the lower cover 5. The first filter 120 and the second filter 121 are separately located on the lower side of the lower cover 5 and installed to the lower cover 5. The lower cover 5 is further provided with a sealing gasket 50, a ring-shaped positioning groove 51, and a matching portion 52. The sealing gasket 50 blocks upward the lower end of the first cylindrical wall 20 and the lower end of the second cylindrical wall 31 to achieve the sealing between the lower end of the first cylindrical wall 20 and the lower cover 5 and between the lower end of the second cylindrical wall 31 and the lower cover 5. The first blocking wall 33 and the second blocking wall 34 separately abut downward against the sealing gasket 50. The sealing gasket 50 blocks the lower end of the counterflow air passage 30, and the first end wall 35 blocks the upper end of the counterflow air passage 30; the first blocking wall 33 and the second blocking wall 34 separately extend downward from the first end wall 35 to the lower cover 5. In an embodiment, the first blocking wall 33 and the second blocking wall 34 separately extend downward from the first end wall 35 to the sealing gasket 50 of the lower cover 5.

The sealing gasket 50 is disc-shaped, the ring-shaped positioning groove 51 surrounds the outer periphery of the sealing gasket 50, and the lower end of the first cylindrical wall 20 is embedded in the ring-shaped positioning groove 51. The center opening of the sealing gasket 50 allows the matching portion 52 to penetrate upward, and the matching portion 52 protrudes upward from the sealing gasket 50 and is embedded in the lower end of the center column 32. The lower end of the center column 32 abuts downward against the sealing gasket 50. In this embodiment, the sealing gasket 50 and the sealing layer 310 are glued and fixed. Similar to the sealing layer 310, the sealing gasket 50 may also be made of PU material or EVA material. The lower cover 5 is further provided with a ring-shaped convex rib 53. The ring-shaped convex rib 53 surrounds the sealing gasket 50. The outer periphery of the sealing gasket 50 abuts on the inner periphery of the ring-shaped convex rib 53. The ring-shaped convex rib 53 is located in the lower end of the first cylindrical wall 20. The ring-shaped convex rib 53 forms the inner groove wall of the ring-shaped positioning groove 51.

The lower cover 5 is further provided with a disc portion 58. The ring-shaped positioning groove 51, the matching portion 52, the ring-shaped convex rib 53, and the sealing gasket 50 are separately disposed on the disc portion 58 to form part of the disc portion 58. The lower cover 5 blocks upward the lower end of the first cylindrical wall 20 and the lower end of the second cylindrical wall 31 through the disc portion 58. The disc portion 58 protrudes downward from the bottom surface of the lower cover 5. The disc portion 58 is further provided with a ring-shaped peripheral wall 54 located on the outer periphery of the disc portion 58. The ring-shaped peripheral wall 54 surrounds the outer periphery of the ring-shaped convex rib 53. The gap between the ring-shaped peripheral wall 54 and the ring-shaped convex rib 53 forms the ring-shaped positioning groove 51. The ring-shaped peripheral wall 54 forms the outer groove wall of the ring-shaped positioning groove 51. The ring-shaped convex rib 53 forms the inner groove wall of the ring-shaped positioning groove 51. In this embodiment, the outer casing 2 is fixed relative to the lower cover 5, and the valve core 3 is movable relative to the lower cover 5. The valve core 3 is located above the disc portion 58 of the lower cover 5 and rotates between the first angular position and the second angular position.

The air sucked by the fan 11 from the dust collection container 10 is discharged into a space between the tray 4 and the upper cover 6. In the case where the counterflow air passage 30 is at the second angular position relative to the outer casing 2, at least part of the air discharged by the fan 11 into the space between the tray 4 and the upper cover 6 may flow backward into the dust collection container 10 through at least the first counterflow inlet 202, the counterflow air inlet 301, the counterflow air passage 30, the counterflow air outlet 300, the first vent opening 200, and the first filter 120 in sequence. In the case where the counterflow air passage 30 is at the third angular position relative to the outer casing 2, at least part of the air discharged by the fan 11 into the space between the tray 4 and the upper cover 6 may flow backward into the dust collection container 10 through at least the second counterflow inlet 203, the counterflow air inlet 301, the counterflow air passage 30, the counterflow air outlet 300, the second vent opening 201, and the second filter 121 in sequence.

The length direction of the center column 32 is parallel to the rotation axis of the valve core 3. The center column 32 extends downward to the lower cover 5. The valve core 3 rotates above the lower cover 5 with the center column 32 as an axis, and the center column 32 forms the shaft of the valve core 3. The lower end of the center column 32 is embedded in the matching portion 52 or the matching portion 52 is embedded in the lower end of the center column 32. In this embodiment, the matching portion 52 is a convex portion protruding upward and embedded in the lower end of the center column 32; the matching portion 52 may also be disposed as a groove so that the lower end of the center column 32 is inserted into the matching portion 52 which is a groove. The first blocking wall 33 and the second blocking wall 34 are located in the outer casing 2. The first blocking wall 33 is opposite to the second blocking wall 34 along the circumferential direction surrounding the rotation axis of the valve core 3. The first blocking wall 33 and the second blocking wall 34 form an included angle. The cross-section of the counterflow air passage 30 is roughly fan-shaped. The first blocking wall 33 and the second blocking wall 34 extend radially from the center column 32 separately. The first blocking wall 33 and the second blocking wall 34 each are an elongated shape extending in the length direction of the center column 32. The first blocking wall 33 is provided with a first side facing away from the center column 32, and the second blocking wall 34 is provided with a second side facing away from the center column 32. The first side and the second side separately extend in a direction parallel to the length direction of the center column 32. The counterflow air outlet 300 and the counterflow air inlet 301 are separately located between the first side and the second side, and the counterflow air outlet 300 and the counterflow air inlet 301 are arranged in a direction parallel to the length direction of the center column 32. In this embodiment, the length direction of the center column 32 is the up-and-down direction, so the counterflow air outlet 300 and the counterflow air inlet 301 are arranged in the up-and-down direction. The first side and the second side are separately located on the second cylindrical wall 31, and the first side and the second side separately extend in the height direction of the second cylindrical wall 31.

The vacuum cleaner further includes a driving motor 14 for driving the valve core 3 to rotate. The shaft (not shown) of the driving motor 14 drives the center column 32 to rotate so as to drive the valve core 3 to rotate. The driving motor 14 is located above the first end wall 35. The center column 32 is integrally connected to the first end wall 35. The center column 32 is provided with a matching end 320 extending beyond the first end wall 35 and abutting against the shaft of the driving motor 14. Multiple first teeth (not shown) are disposed inside the matching end 320, and multiple second teeth (not shown) are disposed on the outer periphery of the shaft of the driving motor 14. The shaft of the driving motor 14 is inserted into the matching end 320 and the first teeth mesh with the second teeth so that the matching end 320 is drivingly connected to the shaft of the driving motor 14. The driving motor 14 is fixed on the top of the outer casing 2.

The outer casing 2 is further provided with a second end wall 21 and a cavity 22. The cavity 22 is recessed from the second end wall 21 toward the first end wall 35. The driving motor 14 is installed and fixed to the outer casing 2 and is at least partially accommodated in the cavity 22. The matching end 320 extends into the cavity 22. The second end wall 21 is located above the first end wall 35, and the matching end 320 extends upward into the cavity 22. The second end wall 21 is roughly disc-shaped, and the first cylindrical wall 20 extends downward from the periphery of the second end wall 21.

Based on the counterflow air passage 30 or the valve core 3 rotating to different angular positions relative to the outer casing 2, the counterflow air passage 30 may selectively communicate with or not communicate with the first vent opening 200 and may selectively communicate with or not communicate with the second vent opening 201. In an embodiment, the counterflow air passage 30 selectively communicates with the first vent opening 200 or communicates with the second vent opening 201, or does not communicate with the first vent opening 200 and the second vent opening 201. The first vent opening 200 may selectively or alternatively communicate with the first air outlet 204 and the counterflow air passage 30, and the second vent opening 201 may selectively or alternatively communicate with the first air outlet 204 and the counterflow air passage 30.

In the case where the counterflow air passage 30 or the valve core 3 is at the first angular position, the first vent opening 200 and the second vent opening 201 separately communicate with the first air outlet 204. In the case where the counterflow air passage 30 or the valve core 3 is at the second angular position, the first vent opening 200 communicates with the counterflow air passage 30, and the second vent opening 201 communicates with the first air outlet 204. In the case where the counterflow air passage 30 is at the third angular position relative to the outer casing 2, the first vent opening 200 communicates with the first air outlet 204, and the second vent opening 201 communicates with the counterflow air passage 30. In the case where the counterflow air passage 30 or the valve core 3 is at the first angular position, under the suction of the fan 11, the airflow filtered by the first filter 120 sequentially flows through at least the first vent opening 200 and the first air outlet 204 to the suction port 111 of the fan 11, and the airflow filtered by the second filter 121 sequentially flows through at least the second vent opening 201 and the first air outlet 204 to the suction port 111 of the fan 11. In the case where the counterflow air passage 30 or the valve core 3 is at the second angular position relative to the outer casing 2, under the suction of the fan 11, the airflow filtered by the second filter 121 sequentially flows through at least the second vent opening 201 and the first air outlet 204 to the suction port 111 of the fan 11. In the case where the counterflow air passage 30 or the valve core 3 is at the third angular position relative to the outer casing 2, under the suction of the fan 11, the airflow filtered by the first filter 120 sequentially flows through at least the first vent opening 200 and the first air outlet 204 to the suction port 111 of the fan 11. The first vent opening 200, the second vent opening 201, and the first air outlet 204 are arranged side by side along the circumferential direction of the outer casing 2. Optionally, the first vent opening 200, the second vent opening 201, and the first air outlet 204 are arranged side by side along the circumferential direction of the first cylindrical wall 20, and the first vent opening 200, the second vent opening 201, and the first air outlet 204 are at the same height.

The vacuum cleaner further includes a first chamber 15, a second chamber 16, and a third chamber 17. The first chamber 15, the second chamber 16, and the third chamber 17 are separately adjacent to the outer casing 2. The first chamber 15, the second chamber 16, and the third chamber 17 are formed by the space between the tray 4 and the lower cover 5. The first vent opening 200 faces the first chamber 15, and the second vent opening 201 faces the second chamber 16. In the case where the counterflow air passage 30 or the valve core 3 is at the first angular position, under the suction of the fan 11, the airflow filtered by the first filter 120 sequentially flows through at least the first chamber 15, the first vent opening 200, and the third chamber 17 to the suction port 111 of the fan 11, and the airflow filtered by the second filter 121 sequentially flows through at least the second chamber 16, the second vent opening 201, and the third chamber 17 to the suction port 111 of the fan 11. Optionally, the first vent opening 200 faces the first chamber 15 along the radial direction of the first cylindrical wall 20, and the second vent opening 201 faces the second chamber 16 along the radial direction of the first cylindrical wall 20.

The lower cover 5 is further provided with a first vent port 55 and a second vent port 56. The first vent port 55 is used for fluidly communicating with the first filter 120 and the first chamber 15, and the second vent port 56 is used for fluidly communicating with the second filter 121 and the second chamber 16. In the case where the counterflow air passage 30 or the valve core 3 is at the first angular position, the airflow filtered by the first filter 120 sequentially flows through at least the first vent port 55, the first chamber 15, the first vent opening 200, and the third chamber 17 to the suction port 111 of the fan 11, and the airflow filtered by the second filter 121 sequentially flows through at least the second vent port 56, the second chamber 16, the second vent opening 201, and the third chamber 17 to the suction port 111 of the fan 11. In the case where the counterflow air passage 30 or the valve core 3 is at the second angular position, under the suction of the fan 11, the airflow filtered by the second filter 121 sequentially flows through at least the second vent port 56, the second chamber 16, the second vent opening 201, and the third chamber 17 to the suction port 111 of the fan 11, and the air sequentially flows backward into the dust collection container 10 through at least the counterflow air passage 30, the first vent opening 200, the first chamber 15, the first vent port 55, and the first filter 120 in sequence. In the case where the counterflow air passage 30 or the valve core 3 is at the third angular position relative to the outer casing 2, under the suction of the fan 11, the airflow filtered by the first filter 120 sequentially flows through at least the first vent port 55, the first chamber 15, the first vent opening 200, and the third chamber 17 to the suction port 111 of the fan 11, and the air flows backward into the dust collection container 10 through at least the counterflow air passage 30, the second vent opening 201, the second chamber 16, the second vent port 56, and the second filter 121 in sequence.

The first vent port 55 and the second vent port 56 separately protrude downward from the bottom surface of the lower cover 5, the first filter 120 is connected to the first vent port 55, the second filter 121 is connected to the second vent port 56, the first vent port 55 is located on the lower side of the first chamber 15 and on the upper side of the first filter 120, and the second vent port 56 is located on the lower side of the second chamber 16 and on the upper side of the second filter 121. The first filter 120 and the second filter 121 are cylindrical filters, the upper end of the first filter 120 is sleeved on the first vent port 55, and the upper end of the second filter 121 is sleeved on the second vent port 56.

The first vent opening 200 is open to the first chamber 15, the second vent opening 201 is open to the second chamber 16, and the first air outlet 204 is open to the third chamber 17. The first vent opening 200 and the first air outlet 204 are used for fluidly communicating the first chamber 15 with the third chamber 17, and the second vent opening 201 and the first air outlet 204 are used for fluidly communicating the second chamber 16 with the third chamber 17. The third chamber 17 is located upstream of the suction port 111 of the fan 11. In the case where the counterflow air passage 30 or the valve core 3 is at the first angular position, the fan 11 sucks the third chamber 17 so that the air in the first chamber 15 and the air in the second chamber 16 flow into the third chamber 17. The first vent opening 200 may form the air inlet of the first chamber 15 and may also form the air outlet of the first chamber 15. The first vent port 55 may form the air inlet of the first chamber 15 and may also form the air outlet of the first chamber 15. The second vent opening 201 may form the air inlet of the second chamber 16 and may also form the air outlet of the second chamber 16. The second vent port 56 may form the air inlet of the second chamber 16 and may also form the air outlet of the second chamber 16. The first vent port 55 may form the air inlet of the inner cavity 1200 of the first filter 120 and may also form the air outlet of the inner cavity 1200 of the first filter 120. The second vent port 56 may form the air inlet of the inner cavity 1210 of the second filter 121 and may also form the air outlet of the inner cavity 1210 of the second filter 121. The inner cavity 1200 of the first filter 120 accommodates a first float 18 for correspondingly blocking the first vent port 55, and the inner cavity 1210 of the second filter 121 accommodates a second float (not shown) for correspondingly blocking the second vent port 56. The first float 18 and the second float can float up along with the rise of the liquid level in the dust collection container 10. In the case where the first float 18 rises to the first vent port 55, the first vent port 55 is blocked, and in the case where the second float rises to the second vent port 56, the second vent port 56 is blocked, thereby preventing the liquid in the dust collection container 10 from being sucked from the first vent port 55 and the second vent port 56. The first float 18 and the second float are, for example, float balls.

The first air outlet 204 faces the third chamber 17. In an embodiment, the first air outlet 204 faces the third chamber 17 along the radial direction of the first cylindrical wall 20. In the case where the counterflow air passage 30 or the valve core 3 is at the first angular position, under the suction of the fan 11, the airflow filtered by the first filter 120 sequentially flows through at least the first chamber 15, the first vent opening 200, the first air outlet 204, and the third chamber 17 to the suction port 111 of the fan 11, and the airflow filtered by the second filter 121 sequentially flows through at least the second chamber 16, the second vent opening 201, the first air outlet 204, and the third chamber 17 to the suction port 111 of the fan 11. In the case where the counterflow air passage 30 or the valve core 3 is at the second angular position, the second filter 121 fluidly communicates with the suction port 111 of the fan 11 through at least the second chamber 16, the second vent opening 201, the first air outlet 204, and the third chamber 17 in sequence, and the counterflow air passage 30 fluidly communicates with the first filter 120 through at least the first vent opening 200 and the first chamber 15 in sequence. Therefore, in this case, the air may flow through the first filter 120 in the reverse direction after sequentially flowing through at least the counterflow air passage 30, the first vent opening 200, and the first chamber 15 so that the blockage in the first filter 120 can be effectively reduced and the cleaning of the first filter 120 can be achieved. In the case where the counterflow air passage 30 or the valve core 3 is at the third angular position, the first filter 120 fluidly communicates with the suction port 111 of the fan 11 through at least the first chamber 15, the first vent opening 200, the first air outlet 204, and the third chamber 17 in sequence, and the counterflow air passage 30 fluidly communicates with the second filter 121 through at least the second vent opening 201 and the second chamber 16 in sequence. In this case, the air may flow through the second filter 121 in the reverse direction after sequentially flowing through the counterflow air passage 30, the second vent opening 201, and the second chamber 16 so that the blockage in the second filter 121 can be effectively reduced and the cleaning of the second filter 121 can be achieved.

The vacuum cleaner further includes a first partition wall 71 for isolating the first chamber 15 and the third chamber 17, a second partition wall 72 for isolating the second chamber 16 and the third chamber 17, and a third partition wall 73 for isolating the first chamber 15 and the second chamber 16. The first partition wall 71, the second partition wall 72, and the third partition wall 73 are separately located between the tray 4 and the lower cover 5. The third chamber 17 is located between the first chamber 15 and the second chamber 16, and the third chamber 17 is located between the first partition wall 71 and the second partition wall 72. The first partition wall 71 has an inner end 710 that abuts on the outer casing 2 and an outer end 711 that abuts on a ring-shaped enclosure (detailed later). The second partition wall 72 has an inner end 720 that abuts on the outer casing 2 and an outer end 721 that abuts on the ring-shaped enclosure. The third partition wall 73 has an inner end 730 that abuts the outer casing 2 and an outer end 731 that abuts on the ring-shaped enclosure. The first air outlet 204 is located between the inner end 710 of the first partition wall 71 and the inner end 720 of the second partition wall 72. The first vent opening 200 is located between the inner end 710 of the first partition wall 71 and the inner end 730 of the third partition wall 73. The second vent opening 201 is located between the inner end 720 of the second partition wall 72 and the inner end 730 of the third partition wall 73. The inner end 710 of the first partition wall 71, the inner end 720 of the second partition wall 72, and the inner end 730 of the third partition wall 73 are arranged side by side along the circumferential direction of the outer casing 2; optionally, the inner end 710 of the first partition wall 71, the inner end 720 of the second partition wall 72, and the inner end 730 of the third partition wall 73 are arranged side by side along the circumferential direction of the first cylindrical wall 20. The inner end 730 of the third partition wall 73 and the first air outlet 204 are located on two opposite sides of the outer casing 2 along the radial direction of the outer casing 2; optionally, the inner end 730 of the third partition wall 73 and the first air outlet 204 are located on two opposite sides of the first cylindrical wall 20 along the radial direction of the first cylindrical wall 20. The lower edge of the first partition wall 71 is downwardly embedded in a first matching groove 570 on the lower cover 5, the lower edge of the second partition wall 72 is downwardly embedded in a second matching groove 571 on the lower cover 5, and the lower edge of the third partition wall 73 is downwardly embedded in a third matching groove 572 on the lower cover 5. In this embodiment, the upper edge of the first partition wall 71, the upper edge of the second partition wall 72, the upper edge of the third partition wall 73, and the upper edge of the ring-shaped enclosure are separately integrally connected to the tray 4.

The tray 4 is further provided with a second air outlet 42 corresponding to the suction port 111 of the fan 11. The second air outlet 42 faces upward the suction port 111 of the fan 11 and faces downward the third chamber 17. The second air outlet 42 is located on the top of the third chamber 17 and between the first partition wall 71 and the second partition wall 72. The outer casing 2 is located between the first chamber 15, the second chamber 16, and the third chamber 17. The second air outlet 42 forms the air outlet of the third chamber 17, and the first air outlet 204 forms the air inlet of the third chamber 17. The first air outlet 204 is roughly located between the suction port 111 of the motor 110 and the third partition wall 73 along the radial direction of the outer casing 2. The inner end 710 of the first partition wall 71 is provided with a first longitudinal groove, the inner end 720 of the second partition wall 72 is provided with a second longitudinal groove, and the inner end 730 of the third partition wall 73 is provided with a third longitudinal groove. The first cylindrical wall 20 is provided with a first longitudinal rib 207, a second longitudinal rib 208, and a third longitudinal rib 209. The first longitudinal rib 207 is embedded in the first longitudinal groove, the second longitudinal rib 208 is embedded in the second longitudinal groove, and the third longitudinal rib 209 is embedded in the third longitudinal groove so that the first cylindrical wall 20 can be positioned more stably. The first air outlet 204 is located between the first longitudinal rib 207 and the second longitudinal rib 208, the first vent opening 200 is located between the first longitudinal rib 207 and the third longitudinal rib 209, and the second vent opening 201 is located between the second longitudinal rib 208 and the third longitudinal rib 209. The first longitudinal rib 207, the second longitudinal rib 208, the third longitudinal rib 209, the first longitudinal groove, the second longitudinal groove, and the third longitudinal groove separately extend in the height direction of the first cylindrical wall 20.

The ring-shaped enclosure is disposed between the tray 4 and the lower cover 5, and the ring-shaped enclosure is ring-shaped. The first chamber 15, the second chamber 16, and the third chamber 17 are distributed in the area defined by the ring-shaped enclosure, and the ring-shaped enclosure surrounds the outer periphery of the outer casing 2 and is spaced apart from the outer casing 2. The first partition wall 71, the second partition wall 72, and the third partition wall 73 are separately connected between the outer casing 2 and the ring-shaped enclosure. The first partition wall 71, the second partition wall 72, and the third partition wall 73 are separately in the shape of a straight bar extending between the outer casing 2 and the ring-shaped enclosure. The area jointly enclosed by the first part 740 of the ring-shaped enclosure, the first partition wall 71, part of the first cylindrical wall 20 located between the first longitudinal rib 207 and the third longitudinal rib 209, and the third partition wall 73 forms the first chamber 15. The area jointly enclosed by the second part 741 of the ring-shaped enclosure, the second partition wall 72, part of the first cylindrical wall 20 located between the second longitudinal rib 208 and the third longitudinal rib 209, and the third partition wall 73 forms the second chamber 16. The area jointly enclosed by the third part 742 of the ring-shaped enclosure, the second partition wall 72, part of the first cylindrical wall 20 located between the first longitudinal rib 207 and the second longitudinal rib 208, and the first partition wall 71 forms the third chamber 17. The first part 740 and the second part 741 are separately C-shaped, and the third part 742 is connected between the first part 740 and the second part 741. The first part 740, the second part 741, and the third part 742 are connected to form a ring. The first part 740 connects the outer end 711 of the first partition wall 71 and the outer end 731 of the third partition wall 73, the second part 741 connects the outer end 721 of the second partition wall 72 and the outer end 731 of the third partition wall 73, and the third part 742 connects the outer end 711 of the first partition wall 71 and the outer end 721 of the second partition wall 72.

The vacuum cleaner further includes a fourth chamber 19 and an air discharging port 80 connecting the outside of the vacuum cleaner and the fourth chamber 19. The fourth chamber 19 is formed between the upper cover 6 and the tray 4. The upper cover 6 and the lower cover 5 are separately fastened to the tray 4 through screws. The outer casing 2 is partially accommodated in the fourth chamber 19, and the fan 11 is located in the fourth chamber 19. The first counterflow inlet 202 and the second counterflow inlet 203 are separately located in the fourth chamber 19. The air sucked in by the suction port 111 of the fan 11 is discharged into the fourth chamber 19, and the air discharged into the fourth chamber 19 by the fan 11 is discharged out of the vacuum cleaner through the air discharging port 80. In the case where the counterflow air passage 30 or the valve core 3 is at the second angular position, part of the air discharged into the fourth chamber 19 by the fan 11 flows backward into the dust collection container 10 through at least the first counterflow inlet 202, the counterflow air passage 30, the first vent opening 200, and the first filter 120 in sequence. Moreover, in this case, another part of the air discharged into the fourth chamber 19 by the fan 11 is discharged out of the vacuum cleaner through the air discharging port 80. In the case where the counterflow air passage 30 or the valve core 3 is at the third angular position, part of the air discharged into the fourth chamber 19 by the fan 11 flows backward into the dust collection container 10 through at least the second counterflow inlet 203, the counterflow air passage 30, the second vent opening 201, and the second filter 121 in sequence. Moreover, in this case, another part of the air discharged into the fourth chamber 19 by the fan 11 is discharged out of the vacuum cleaner through the air discharging port 80.

In this embodiment, the air discharged by the fan 11 forms the air source of the counterflow air passage 30. The outer casing 2 may also be disposed to be located at other positions so that the first counterflow inlet 202 and the second counterflow inlet 203 are located outside the fourth chamber 19 (for example, the first counterflow inlet 202 and the second counterflow inlet 203 are located between the housing 81 and the upper cover 6), and an opening is disposed on the housing 81 so that the air outside the vacuum cleaner can be directly introduced and supplied to the first counterflow inlet 202 and the second counterflow inlet 203. The fourth chamber 19 is provided with a first air guiding channel 190 for guiding air toward the air discharging port 80 and a second air guiding channel 191 for guiding air toward the air discharging port 80. The first air guiding channel 190 and the second air guiding channel 191 are arc-shaped. The first counterflow inlet 202 and the second counterflow inlet 203 are located in the first air guiding channel 190. The first air guiding channel 190 is surrounded by multiple arc-shaped baffles 192 in the fourth chamber 19. The vacuum cleaner is further provided with a silencer sponge 82, and the silencer sponge 82 is located in the fourth chamber 19 and enclosed in a circle.

To sum up, in the case where the valve core 3 or the counterflow air passage 30 is at the first angular position, the first vent opening 200, the second vent opening 201, and the counterflow air passage 30 are all blocked, and under the suction of the fan 11, the dust, debris, and other garbage along with the air enter the dust collection container 10 from the suction port 100. Part of the air entering the dust collection container 10 is filtered by the first filter 120, sequentially flows through the first vent port 55, the first chamber 15, the first vent opening 200, the first air outlet 204, the third chamber 17, the second air outlet 42, and the suction port 111 of the fan 11, and is discharged into the fourth chamber 19 and then discharged out of the vacuum cleaner through the air discharging port 80. Another part of the air entering the dust collection container 10 is filtered by the second filter 121, sequentially flows through the second vent port 56, the second chamber 16, the second vent opening 201, the first air outlet 204, the third chamber 17, the second air outlet 42, and the suction port 111 of the fan 11, and is discharged into the fourth chamber 19 and then discharged out of the vacuum cleaner through the air discharging port 80.

In the case where the valve core 3 or the counterflow air passage 30 is at the second angular position, the counterflow air inlet 301 is aligned with the first counterflow inlet 202 and the counterflow air outlet 300 is aligned with the first vent opening 200, so that the first counterflow inlet 202 communicates with the first vent opening 200. In this case, under the suction of the fan 11, the air filtered by the second filter 121 sequentially flows through the second vent port 56, the second chamber 16, the second vent opening 201, the first air outlet 204, the third chamber 17, the second air outlet 42, and the suction port 111 of the fan 11 and is discharged into the fourth chamber 19. Moreover, part of the air discharged into the fourth chamber 19 flows backward into the dust collection container 10 through the first counterflow inlet 202, the counterflow air inlet 301, the counterflow air passage 30, the counterflow air outlet 300, the first vent opening 200, the first chamber 15, the first vent port 55, and the first filter 120 in sequence, and in this process, the air flows through the first filter 120 in the reverse direction, thereby cleaning the first filter 120.

In the case where the valve core 3 or the counterflow air passage 30 is at the third angular position, the counterflow air inlet 301 is aligned with the second counterflow inlet 203, and the counterflow air outlet 300 is aligned with the second vent opening 201, so that the counterflow air inlet 301 communicates with the second vent opening 201. In this case, under the suction of the fan 11, the air filtered by the first filter 120 sequentially flows through the first vent port 56, the first chamber 15, the first vent opening 200, the first air outlet 204, the third chamber 17, the second air outlet 42, and the suction port 111 of the fan 11 and is discharged into the fourth chamber 19. Moreover, part of the air discharged into the fourth chamber 19 flows backward into the dust collection container 10 through the second counterflow inlet 203, the counterflow air outlet 301, the counterflow air passage 30, the counterflow air outlet 300, the second vent opening 201, the first chamber 15, the second vent port 56, and the second filter 121 in sequence, and in this process, the air flows through the second filter 121 in the reverse direction, thereby cleaning the second filter 121.

For this vacuum cleaner, the fan 11, the first filter 120, the second filter 121, the tray 4, the upper cover 6, the lower cover 5, the housing 81, the switching valve apparatus, and the driving motor 14 are separately part of the head 83 of this vacuum cleaner. The head 83 is detachably installed in the dust collection container 10. The first filter 120 and the second filter 121 are located at the bottom of the head 83 and in the dust collection container 10. The fan 11, the switching valve apparatus, and the driving motor 14 are separately located inside the head 83. The head 83 is detachably installed to the upper end of the dust collection container 10 through a buckle 86. The head 83 may be detached from the upper end of the dust collection container 10 as a whole. The head 83 is provided with a handle 84, and the handle 84 is used for moving this vacuum cleaner. The bottom of the vacuum cleaner is further provided with multiple wheels 85 for moving this vacuum cleaner.

In the case where this vacuum cleaner is stopped, the valve core 3 remains at the first angular position. After this vacuum cleaner is turned on, the fan 11 may start to run to form the suction airflow. Under the driving of the driving motor 14, the valve core 3 first rotates from the first angular position to the second angular position along the rotation direction and remains at the second angular position for n seconds (n may be 2 seconds), thereby completing the cleaning of the first filter 120 once; and then the valve core 3 rotates from the second angular position to the third angular position against the rotation direction and remains at the third angular position for n seconds, thereby completing the cleaning of the second filter 121 once; and then the valve core 3 rotates from the third angular position to the second angular position along the rotation direction and remains at the second angular position for n seconds. The valve core 3 may remain at the second angular position and the third angular position for multiple rounds so that the first filter 120 and the second filter 121 can be cleaned many times. After the cleaning of the first filter 120 and the second filter 121 is completed, the valve core 3 returns to the first angular position, and then the fan 11 performs normal suction work.

In the case where the valve core 3 or the counterflow air passage 30 is at the first angular position, a first forward air passage is formed between the first filter 120 and the suction port 111 of the fan 11, and a second forward air passage is formed between the second filter 120 and the suction port 111 of the fan 11. The first forward air passage sequentially passes through the first vent port 55, the first chamber 15, the first vent opening 200, the first air outlet 204, the third chamber 17, and the second air outlet 42, and the first forward air passage passes from the first filter 120 through the first vent port 55, the first chamber 15, the first vent opening 200, the first air outlet 204, the third chamber 17, and the second air outlet 42 in sequence to the suction port 111 of the fan 11. The second forward air passage sequentially passes through the second vent port 56, the second chamber 16, the second vent opening 201, the first air outlet 204, the third chamber 17, and the second air outlet 42, and the second forward air passage passes from the second filter 121 through the second vent port 56, the second chamber 16, the second vent opening 201, the first air outlet 204, the third chamber 17, and the second air outlet 42 in sequence to the suction port 111 of the fan 11. The airflow filtered by the first filter 120 flows along the first forward air passage to the suction port 111 of the fan 11, and the airflow filtered by the second filter 121 flows along the second forward air passage to the suction port 111 of the fan 11.

In the case where the valve core 3 or the counterflow air passage 30 is switched to the second angular position, a first reverse air passage is formed between the first filter 120 and the first counterflow inlet 202, and the second filter 120 fluidly communicates with the suction port 111 of the fan 11 still through the aforementioned second forward air passage. In this case, the airflow filtered by the second filter 121 flows along the second forward air passage to the suction port 111 of the fan 11. The first reverse air passage passes through the counterflow air passage 30 and the first vent opening 200. In an embodiment, the first reverse air passage sequentially passes through the first counterflow inlet 202, the counterflow air inlet 301, the counterflow air passage 30, the counterflow air outlet 300, the first vent opening 200, the first chamber 15, and the first vent port 55. The first reverse air passage passes from the first counterflow inlet 202 through the counterflow air inlet 301, the counterflow air passage 30, the counterflow air outlet 300, the first vent opening 200, the first chamber 15, and the first vent port 55 in sequence to the first filter 120.

In the case where the valve core 3 or the counterflow air passage 30 is at the third angular position, a second reverse air passage is formed between the second filter 120 and the second counterflow inlet 203, and the first filter 120 fluidly communicates with the suction port 111 of the fan 11 still through the aforementioned first forward air passage. In this case, the airflow filtered by the first filter 120 flows along the first forward air passage to the suction port 111 of the fan 11. The second reverse air passage passes through the counterflow air passage 30 and the second vent opening 201. In an embodiment, the second reverse air passage sequentially passes through the second counterflow inlet 203, the counterflow air inlet 301, the counterflow air passage 30, the counterflow air outlet 300, the second vent opening 201, the first chamber 15, and the second vent port 56. The second reverse air passage passes from the second counterflow inlet 203 through the counterflow air inlet 301, the counterflow air passage 30, the counterflow air outlet 300, the second vent opening 201, the first chamber 15, and the second vent port 55 in sequence to the second filter 121.

The switching valve apparatus of this vacuum cleaner rotates relative to the outer casing 2 in the outer casing 2 through the counterflow air passage 30 or the valve core 3 so that the switching of the air passage can be achieved conveniently and efficiently. The mechanism of the switching valve apparatus is novel and ingenious and occupies a concentrated space so that the spatial layout can be facilitated. The first reverse air passage is an air passage between the first filter 120 and the fourth chamber 19, and the second reverse air passage is an air passage between the second filter 121 and the fourth chamber 19. The first reverse air passage is used for cleaning the first filter 120, the second reverse air passage is used for cleaning the second filter 121, and the first forward air passage and the second forward air passage are separately used for forward suction of the air. In the case where the counterflow air passage 30 or the valve core 3 is at the first angular position, the fan 11 performs suction through the two air passages (the first forward air passage and the second forward air passage). In the case where the counterflow air passage 30 or the valve core 3 is switched to the second angular position, the first filter 120 cleans the blockage in the first filter 120 through the first reverse air passage, and the fan 11 performs suction through the second forward air passage corresponding to the second filter 121. In the case where the counterflow air passage 30 or the valve core 3 is switched to the third angular position, the second filter 121 cleans the blockage in the second filter 121 through the second reverse air passage, and the fan 11 performs suction through the first forward air passage corresponding to the first filter 120. It can be seen that no matter whether the counterflow air passage 30 or the valve core 3 is switched to the second angular position or the third angular position, a forward air passage for forward suction and a reverse air passage for cleaning the filter exist at the same time so that a better cleaning effect on the filter can be ensured.

1. (canceled)

2. (canceled)

3. A vacuum cleaner, comprising a dust collection container, a fan, a first filter, and a second filter, and further comprising a switching valve apparatus, wherein,
the switching valve apparatus comprises an outer casing and a counterflow air passage at least partially located in the outer casing, the outer casing is provided a first vent opening corresponding to the first filter and a second vent opening corresponding to the second filter;
the counterflow air passage is rotatable to different angular positions relative to the outer casing so that the counterflow air passage is capable of selectively communicating with the first vent opening or communicating with the second vent opening, or being staggered with the first vent opening and the second vent opening;
the counterflow air passage is provided with a counterflow air outlet;
in a case where the counterflow air passage is at a first angular position, the outer casing is configured to seal the counterflow air outlet and the counterflow air outlet is configured to stagger with the first vent opening and the second vent opening, and at this time under suction of the fan, airflow filtered by the first filter flows through at least the first vent opening to a suction port of the fan, and airflow filtered by the second filter flows through at least the second vent opening to the suction port of the fan;
in a case where the counterflow air passage is at a second angular position, the counterflow air outlet is configured to be in communication with the first vent opening and staggered with the second vent opening, and at this time under the suction of the fan, the airflow filtered by the second filter flows through at least the second vent opening to the suction port of the fan, and air flows backward into the dust collection container through at least the counterflow air passage, the counterflow air outlet, the first vent opening, and the first filter in sequence; and
in a case where the counterflow air passage is at a third angular position, the counterflow air outlet is configured to be in communication with the second vent opening and staggered with the first vent opening, and at this time under the suction of the fan, the airflow filtered by the first filter flows through at least the first vent opening to the suction port of the fan, and air flows backward into the dust collection container through at least the counterflow air passage, the counterflow air outlet, the second vent opening, and the second filter in sequence.

4. The vacuum cleaner of claim 3, further comprising a first chamber, a second chamber, and a third chamber, wherein,
the first vent opening and the second vent opening are disposed on an outer periphery of the outer casing, the outer casing is further provided with a first air outlet located on the outer periphery of the outer casing, the first vent opening is configured to face the first chamber along a first radial direction of the outer casing, the second vent opening is configured to face the second chamber along a second radial direction of the outer casing, and the first air outlet is configured to face the third chamber along a third radial direction of the outer casing;
in the case where the counterflow air passage is at the first angular position, the first vent opening is configured to be in communication between the first chamber and the first air outlet, and the second vent opening is configured to be in communication between the second chamber and the first air outlet;
in the case where the counterflow air passage is at the second angular position, the first vent opening is configured to be in communication between the first chamber and the counterflow air passage, and the second vent opening is configured to be in communication between the second chamber and the first air outlet; and
in the case where the counterflow air passage is at the third angular position, the first vent opening is configured to be in communication between the first chamber and the first air outlet, and the second vent opening is configured to be in communication between the second chamber and the counterflow air passage.

5. The vacuum cleaner of claim 3, wherein the outer casing is further provided with a first cylindrical wall, the first cylindrical wall is disposed surrounding an outer periphery of the counterflow air passage, and the first vent opening and the second vent opening are separately disposed on the first cylindrical wall;
the counterflow air passage is rotatable relative to the outer casing between the second angular position and the third angular position; and
the counterflow air passage is capable of rotating relative to the outer casing from the first angular position to the second angular position along a rotation direction, and rotating relative to the outer casing from the second angular position to the third angular position against the rotation direction; and the counterflow air passage is configured to pass through the first angular position during rotating from the second angular position to the third angular position against the rotation direction.

6. The vacuum cleaner of claim 5, wherein the outer casing is further provided with a first counterflow inlet and a second counterflow inlet, the first counterflow inlet and the second counterflow inlet are separately disposed on the first cylindrical wall, and the counterflow air passage is provided with a counterflow air inlet;
in the case where the counterflow air passage is at the second angular position, the counterflow air inlet is configured to be aligned with and in communication with the first counterflow inlet, and the counterflow air outlet is aligned with and communicates with the first vent opening; and
in the case where the counterflow air passage is at the third angular position, the counterflow air inlet is configured to be aligned with and in communication with the second counterflow inlet, and the counterflow air outlet is configured to be aligned with and in communication with the second vent opening.

7. The vacuum cleaner of claim 6, further comprising a tray and a lower cover located on a lower side of the tray, wherein the tray is provided with a first installation through opening penetrating through the tray from an upper side of the tray to the lower side of the tray, the first cylindrical wall penetrates through the first installation through opening in an up-and-down direction, the first vent opening and the second vent opening are separately located between the tray and the lower cover, and the first counterflow flow air inlet and the second counterflow inlet are separately located on the upper side of the tray.

8. The vacuum cleaner of claim 5, wherein the switching valve apparatus further comprises a valve core at least partially accommodated in the outer casing and rotatable relative to the outer casing, the counterflow air passage is disposed in the valve core,
the valve core is further provided with a second cylindrical wall, the first cylindrical wall is sleeved outside the second cylindrical wall, and the counterflow air outlet is disposed on the second cylindrical wall; and
in the case where the counterflow air passage is at the first angular position, the first cylindrical wall is configured to seal the counterflow air outlet.

9. The vacuum cleaner of claim 8, wherein the counterflow air passage is further provided with a counterflow air inlet, and the counterflow air inlet is disposed on the second cylindrical wall; and in the case where the counterflow air passage is at the first angular position, the first cylindrical wall is configured to seal the counterflow air inlet.

10. The vacuum cleaner of claim 9, wherein the outer casing is further provided with a first counterflow inlet and a second counterflow inlet, and the first counterflow inlet and the second counterflow inlet are separately disposed on the first cylindrical wall;
in the case where the counterflow air passage is at the second angular position, the counterflow air inlet is configured to be in communication with the first counterflow inlet, and the second cylindrical wall is configured to seal the second counterflow inlet; and
in the case where the counterflow air passage is at the third angular position, the counterflow air inlet is configured to be in communication with the second counterflow inlet, and the second cylindrical wall is configured to seal the first counterflow inlet.

11. The vacuum cleaner of claim 9, wherein the second cylindrical wall comprises a flexible sealing layer disposed on an outer peripheral surface of the second cylindrical wall, and the sealing layer is configured to seal a gap between an inner surface of the first cylindrical wall and the second cylindrical wall; and the first cylindrical wall and the second cylindrical wall are disposed coaxially.

12. The vacuum cleaner of claim 8, further comprising a lower cover, wherein the first vent opening and the second vent opening are separately located on an upper side of the lower cover, the outer casing is fixed relative to the lower cover, the valve core is movable relative to the lower cover, and the lower cover is configured to block upward a lower end of the first cylindrical wall and a lower end of the second cylindrical wall.

13. The vacuum cleaner of claim 3, wherein the outer casing is further provided with a first counterflow inlet and a second counterflow inlet;
in the case where the counterflow air passage is at the second angular position, the first counterflow inlet is configured to be in communication with the first vent opening through the counterflow air passage; and
in the case where the counterflow air passage is at the third angular position, the second counterflow inlet is configured to be in communication with the second vent opening through the counterflow air passage.

14. The vacuum cleaner of claim 13, wherein the counterflow air passage is provided with a counterflow air inlet, the counterflow air inlet forms an air inlet of the counterflow air passage, and the counterflow air outlet forms an air outlet of the counterflow air passage;
in the case where the counterflow air passage is at the second angular position, the first counterflow inlet is configured to be in communication with the counterflow air inlet and the counterflow air outlet is configured to be communication with the first vent opening, so that the first counterflow inlet is in communication with the first vent opening through the counterflow air passage; and
in the case where the counterflow air passage is at the third angular position, the second counterflow inlet is configured to be in communication with the counterflow air inlet and the counterflow air outlet is configured to be in communication with the second vent opening, so that the second counterflow inlet is in communication with the second vent opening through the counterflow air passage.

15. The vacuum cleaner of claim 14, wherein in the case where the counterflow air passage is at the second angular position, the first counterflow inlet is configured to be aligned with and in communication with the counterflow air inlet, and the counterflow air outlet is configured to be aligned with and in communication with the first vent opening; and
in the case where the counterflow air passage is at the third angular position, the second counterflow inlet is configured to be aligned with and thus in communication with the counterflow air inlet, and the counterflow air outlet is configured to be aligned with and thus in communication with the second vent opening.

16. The vacuum cleaner of claim 14, wherein in the case where the counterflow air passage is at the first angular position, the outer casing is configured to seal the counterflow air outlet and the counterflow air inlet, and at this time, the counterflow air outlet is staggered with the first vent opening and the second vent opening, and the counterflow air inlet is staggered with the first counterflow inlet and the second counterflow inlet.

17. The vacuum cleaner of claim 14, wherein in the case where the counterflow air passage is at the first angular position, the first vent opening, the counterflow air outlet, and the second vent opening are arranged in sequence along a circumferential direction of the outer casing, and the first counterflow inlet, the counterflow air inlet, and the second counterflow inlet are arranged in sequence along the circumferential direction of the outer casing.

18. The vacuum cleaner of claim 13, wherein the switching valve apparatus further comprises a valve core at least partially accommodated in the outer casing and rotatable relative to the outer casing, the counterflow air passage is disposed in the valve core, and the counterflow air passage is configured to rotate along with rotation of the valve core; and in the case where the counterflow air passage is at the first angular position, the valve core is configured to seal the first counterflow inlet and the second counterflow inlet.

19. The vacuum cleaner of claim 13, wherein the first vent opening and the second vent opening are arranged side by side along a circumferential direction of the outer casing, the first counterflow inlet and the second counterflow inlet are arranged side by side along the circumferential direction of the outer casing, the first vent opening and the first counterflow inlet are arranged side by side in a height direction of the outer casing, and the second vent opening and the second counterflow inlet are arranged side by side in the height direction of the outer casing.

20. The vacuum cleaner of claim 13, further comprising a tray, a lower cover located on a lower side of the tray, and an upper cover located on an upper side of the tray, wherein the counterflow air passage is provided with a counterflow air inlet, the first vent opening and the second vent opening are separately located between the tray and the lower cover, and the first counterflow inlet and the second counterflow inlet are separately located between the tray and the upper cover; in the case where the counterflow air passage is at the second angular position, at least part of air discharged by the fan into a space between the tray and the upper cover flows backward into the dust collection container through at least the first counterflow inlet, the counterflow air inlet, the counterflow air passage, the counterflow air outlet, the first vent opening, and the first filter in sequence; and in the case where the counterflow air passage is at the third angular position, at least part of the air discharged by the fan into the space between the tray and the upper cover flows backward into the dust collection container through at least the second counterflow inlet, the counterflow air inlet, the counterflow air passage, the counterflow air outlet, the second vent opening, and the second filter in sequence.

21. The vacuum cleaner of claim 3, wherein the switching valve apparatus further comprises a valve core at least partially accommodated in the outer casing and rotatable relative to the outer casing, the valve core is provided with a first blocking wall and a second blocking wall, the first blocking wall and the second blocking wall are located in the outer casing, and the counterflow air passage is formed between the first blocking wall and the second blocking wall; and
the vacuum cleaner further comprises a driving motor for driving the valve core to rotate, the valve core is further provided with a center column, the driving motor is capable of driving the center column to rotate to drive the valve core to rotate, and the first blocking wall and the second blocking wall are separately integrated with and extend from the center column.

22. The vacuum cleaner of claim 3, wherein the outer casing is further provided with a first air outlet; the first vent opening, the second vent opening, and the first air outlet are separately disposed on the outer periphery of the outer casing;
in the case where the counterflow air passage is at the first angular position, the first vent opening and the second vent opening are configured to be separately in communication with the first air outlet, and at this time under the suction of the fan, the airflow filtered by the first filter sequentially flows through at least the first vent opening and the first air outlet to the suction port of the fan, and the airflow filtered by the second filter sequentially flows through at least the second vent opening and the first air outlet to the suction port of the fan;
in the case where the counterflow air passage is at the second angular position, the second vent opening is configured to be communication with the first air outlet, and at this time under the suction of the fan, the airflow filtered by the second filter sequentially flows through at least the second vent opening and the first air outlet to the suction port of the fan;
in the case where the counterflow air passage is at the third angular position, the first vent opening is configured to be in communication with the first air outlet, and at this time under the suction of the fan, the airflow filtered by the first filter sequentially flows through at least the first vent opening and the first air outlet to the suction port of the fan; and
the first vent opening, the second vent opening, and the first air outlet are arranged side by side along a circumferential direction of the outer casing.
